(19) United States
(12) Patent Application Publication
(10) Pub. No.: US 2014/0316562 A1
(43) Pub. Date: Oct. 23, 2014

(54) IDENTIFICATION CARD DISPENSER AND OPERATION METHOD THEREOF

(71) Applicants: Miguel Guilherme Leitmann, Carnaxide (PT); Bento Antonio Brazio Correia, Carnaxide (PT)

(72) Inventors: Miguel Guilherme Leitmann, Carnaxide (PT); Bento Antonio Brazio Correia, Carnaxide (PT)

(73) Assignee: VISION BOX-SOLUCOES DE VISAO POR COMPUTADOR, Carnaxide (PT)

(21) Appl. No.: 14/346,812

(22) PCT Filed: Sep. 23, 2011
(86) PCT No.: PCT/PT2011/000032

§ 371 Date: Jul. 7, 2014

(51) Int. Cl. G07F 11/16; G07F 11/52

(52) U.S. Cl. CPC G07F 11/165; G07F 11/52
USPC 700/237; 221/210; 221/154; 221/3; 700/232

(57) ABSTRACT

Identification card (ID) dispenser comprising an ID card storage module (20) for receiving and coupling with one or more ID card containers (30) with a plurality of positions for receiving an ID card; an ID card extractor (60) for picking ID cards from the ID card containers (30); wherein the ID card extractor (60) has access to the individual ID card positions of the ID card containers (30); and the ID card containers (30) are removable from the dispenser and suitable for uncoupling from the ID card storage module (20); optionally comprising a confirmation slip printer, a touch screen, a bank note reader and respective opening, and a card reader (4) and respective opening, in a user interaction module; optionally comprising a biometric module (40). Therefore, the present invention is useful for applications in the areas of ID card production, transport and management, and final user dispensing.

### TECHNICAL FIELD

The present invention relates to identification card dispensing and management by automated means.

### BACKGROUND ART

The use of electronic identification (ID) documents is on the increase all over the world. The growth of the amount of institutions and states that have started to use this new technology has started some years ago, but in the latest years the demand has raised to a very high number. It is noted that ID card or ID document are used interchangeably in this document, whether contact or contactless, electronic or not.

Even if it may be considered that there are no critical constraints in increasing the number of ID cards produced, in the delivery and renewal of the existing cards, this is a de facto problem. For improving the speed, security and assist citizens in having a positive experience when they interact with services for renewal or delivery of electronic documents, electronic card dispensers ware built. These kind of systems allow, in an automatic way, to deliver the new electronic document to the final user. Nevertheless, some constraints exist:
Once the cards are inserted, they should only be replaced when ALL of them have been delivered. It is easy to understand that being able to access previously existing cards when inserting new ones is not a secure process. This then leads to a problem: some cards stay in the dispenser during several months, until the issuance authority decides to remove them, and insert again more cards. During this time, the dispenser is not used at 100%, and more dispensers are needed to deliver the electronic documents (almost obligatory since typically some of them will work half empty during several months);
Alternatively, the cards may be manually removed much more frequently, in order to better manage the dispenser card capability, but this worsens the security problem;
The cards can be inserted manually inside the dispenser, one by one, such that empty positions can be occupied by new cards, but this takes much too long, and can lead to error in insertions; Further, this also imposes the cards to be manually handled, which worsens the security problem.
The transportation of the cards, from the document printing facilities to the dispenser is made in an insecure way. The electronic document is accessible to almost everyone that could easily damage or stolen it;
The dispensers can only deliver cards, not being able to proceed in card renewal processes, including the enrolment of biometric data.

### DISCLOSURE OF THE INVENTION

The electronic identification (ID) document dispenser is a modular system, with the capability to extend or decrease size and card storage capacity, under the client specifications. The dispenser comprises in a preferred embodiment two main modules: the biometric module 40 and the ID card storage module 20. The dispenser can be used without the biometric module 40, working has a stand-alone unit. Also, in the opposite way, the same biometric unit 40 can work with several card storage modules 20, physically coupled or just electronically connected. The dispenser comprises a card storage module 20 which comprises extractable card containers 30.

The card containers 30 should enable direct access to any of its card receiving positions.

The dispenser provides a number of positions for receiving the card containers 30 which are extractable from the dispenser. Empty containers 30 are then able to be extracted and returned to again be used and filled with new cards. The empty container position in the dispenser is replaced with a full container, immediately or at a later time. This has the advantages of ease and speed of operation of all card operations, especially in reloading cards into the dispenser which is thus much faster. A preferred container embodiment 31 is circular, thus enabling direct access to any of its card receiving positions.

The card containers 32 optionally comprise an enclosure 50 such that the cards are not accessible when in transport. This enclosure 50 is such that it can only be opened when inside the dispenser. This has advantages in terms of security of the cards when in transport and in reloading and unloading operations.

The card containers 32 optionally comprise an identification, e.g. an id number, preferably machine-readable, e.g. chip 51, barcode, number, such that the dispenser is able to identify the cards in the container by looking up a card inventory in a suitable database, without needing to access all cards in the container.

The card containers 32 optionally comprise a card inventory in a suitable storage, e.g. a chip 51 or even one the ID cards especially reserved for this purpose, such that the dispenser is able to identify the cards without needing to access all cards in the container.

The card containers 32 optionally comprise active electronics, e.g. a chip 51 or a mobile modem unit, which are able to record, sound an alarm and/or send an electronic communication, e.g. mobile communication, to signal an unauthorised opening—typically if the container is open when in transport between production site and the dispenser.

An individual card extractor 60 is provided to remove and/or insert cards into the card containers 30. Although the extractor 60 will only usually be used to remove cards, it may also insert cards in specific situations back into the card containers 30—the card delivery transaction was interrupted for some reason and the card needs to be restored, or a set of new cards is manually inserted into the dispenser, or simply the dispenser is rearranging cards between containers 30.

The extraction or insertion may also be provided by making use of the card weight. The cards may be accessed by moving the card container 30 towards a card extractor 60 or by moving the card extractor 60 along the card containers 30. These may even be combined—a card extractor 60 may move between the card containers 30 and each individual card container 30 only needs to move the specified card position towards the card extractor 60. Alternatively, the card container 30 with the specified card position may move towards the card extractor 60 and the card extractor 60 will only need to move along that card container 30 to access the specified card position.

The card containers may be linear 33, circular 31, 32, 34, 35 or in other suitable shapes. If circular, a preferable embodiment (FIG. 14) has the card extractor 60 traversing between the card containers 30 and the card containers 30 rotating so that the specified card position will rotate towards the extractor 60. In this embodiment, the containers may operate like carousels, rotating horizontally, or like a Ferris wheel, rotating vertically. The card containers 30 may also be organized in 2D or 3D, with a preferred embodiment being container shelves, in particular vertically and transversally accessible by a card extractor and, in particular, the shelves being movable horizontally towards the card extractor.

The dispenser is able, namely by use of the card extractor 60, to rearrange the cards within the dispenser so that if sufficient empty card positions are present, one or more containers 30 can be emptied and, subsequently, extracted and, optionally, replaced by new containers 30. This rearrangement of the cards is preferably carried out at inoperative times of the dispenser, for example, after opening hours or during operation breaks. This has advantages in terms of efficiency of operation of the dispenser, enabling that left-over cards can be rearranged and empty locations are re-used with ease. Further, this improves security of the cards, because left-over cards can be stored compactly and thus requiring much less frequent unloading operations. If the containers are also securely enclosed, then the full cycle of card dispensing is securely operated, with no operator ever needing, or being able, to manipulate ID cards.

The ID card dispenser may operate with a user interaction module 10 but without a biometric module (FIG. 1), with a user interaction module 10 and biometric module 40 (FIG. 2), without a user interaction module and with a biometric module 40 (FIG. 14), or even only with the card storage module 20, depending on the operation mode required.

A preferred embodiment the data container 31, 32, 34 is circular and has a radial ouverture for inserting into a rotation axis. This has the advantages of the ease of loading and unloading of the containers, but also it is particularly easy to rotate a full stack of containers in this way by rotating a single axis. Preferably, if the data container 32, 34 is enclosed, the rotation of the axis unlocks and locks the enclosure 50. This has the advantage of the ease of locking and locking of a full stack of containers by rotating a single axis.

If using linear card containers 33, a preferable embodiment has the card containers 30 moved in translation movement and the card extractor accessing a specified card position. In a further preferred embodiment, the containers may be moved like in a Ferris wheel. The card containers 33 may also be organized in 2D or 3D, with a preferred embodiment being in shelving walls, in particular vertically and transversally accessible by a card extractor and, in particular, the shelves being movable horizontally towards the card extractor, not unlike movable library shelves.

A preferred circular card container 34 may comprise a connector 52 between consecutive card containers so that the card container axis is only used for holding the card containers, optionally for locking/unlocking its enclosure 50. In this case the card containers 34 are not rotated by said axis, but are rotated by a neighbour card container 34. Preferably, a single card container 34 is mechanically rotated for each container stack, by a motor.

A preferred embodiment 35 dispenses with the ouverture for the central axis. In this case, holding means suitable for the rotation and insertion/removal of each container should be provided. This has the advantage of fully utilizing the circular space of the card container 35 so that no storage space is wasted by said ouverture.

The system can be used for 3 main proposes:

### Card Delivery with/without Biometric Checks

The system can store electronic documents for automatic delivery, and use or not biometric authentication (face, fingerprint, iris, or a combination of them), allowing the citizen, the final user, to pick up the electronic document from the dispenser. This can be the normal workflow for the citizen:
1—Citizen goes to a specific dispenser, indicated by the electronic document issuance authority, after the process of card renewal/issuance has been completed,
2—Citizen inserts on the main screen the ID Card Number or other number, or any kind of personally identifiable information, as indicated by the issuance authority
3—Citizen performs a biometric check (if required), comparing the live biometric data captured, with the data stored on the document and/or the biometric data stored on the issuance authority database.
4—Citizen optionally is required to pay for the service, e.g. with bank notes or credit card, the specific amount of money that is displayed on the screen.
5—Dispenser delivers the document to the citizen and sends the delivery information to the database of the issuance authority.
6—Dispenser optionally prints a confirmation slip to the citizen
7—All the operation is optionally recorded by a CCTV camera installed on the dispenser.

### Card Renewal with/without Biometric Checks

The dispenser can also proceed to the card renewal collection process. This can be the normal workflow for card Renewal:
1—Citizen goes to a specific dispenser, indicated by the electronic document issuance authority after the process of card renewal/issuance has been completed.
2—Citizen inserts the old ID card. The dispenser will verify if the card has all the conditions for being renewed, optionally by communicating electronically with the ID card. This exchange and verification of information is optionally also made between the dispenser and the central server database of the issuance authority.
3—If the card is determined valid for renewal, the dispenser will optionally perform a biometric check, matching the biometrics stored on the card, and/or on the central database, with the live biometrics captured.
4—If required and the biometric check is ok, new biometrics can be optionally enrolled by the dispenser, to keep them up to date in the new card and/or central database.
5—Citizen optionally is required to pay for the service, e.g. with bank notes or credit card, the specific amount displayed on the screen.
6—Dispenser optionally prints a confirmation slip.
7—The old card is stored on a card container. All the information is sent to the central server of the issuance authority, and the document issuance lifecycle will begin.
8—All the operation is optionally recorded by a CCTV camera installed on the dispenser.

### Card Renewal and Delivery with/without Biometric Checks

The dispenser can also proceed to the card renewal collection and delivery process. This can be the normal workflow for card Renewal:
1—Citizen goes to a specific dispenser, indicated by the electronic document issuance authority after the process of card renewal/issuance has been completed.
2—Citizen inserts the old ID card. The dispenser will verify if the card has all the conditions for being renewed, optionally by communicating electronically with the ID card. This exchange and verification of information is optionally also made between the dispenser and the central server database of the issuance authority.
3—If the card is determined valid for renewal, the dispenser will optionally perform a biometric check, matching the biometrics stored on the card, and/or on the central database, with the live biometrics captured.
4—If required and the biometric check is ok, new biometrics can be optionally enrolled by the dispenser, to keep them up to date in the new card and/or central database.
5—Citizen optionally is required to pay for the service, e.g. with bank notes or credit card, the specific amount displayed on the screen.
6—Dispenser optionally prints a confirmation slip.
7—Dispenser delivers the document to the citizen.
8—The old card is stored on a card container. All the information is sent to the central server of the issuance authority, and the document issuance lifecycle is completed.
8—All the operation is optionally recorded by a CCTV camera installed on the dispenser.

In a preferred embodiment the present dispenser device comprises an optional biometric Module and one or more dispenser modules, which in turn comprise one or more storage modules. Each storage module is able to receive one or more card containers.

### Biometric Module—Enrolment and Renewal Unit

This module is optional and comprises biometric sensors. These preferably comprise two fingerprint readers used for capture and matching performance. The system preferably uses also two high quality cameras, one for face enrolment and matching, and other for live video recording of all the delivery and renewal process. Automatic eye finding and height adjustment also are preferable features of this system. The quality of the pictures is preferably automatically evaluated with a special sensor that detects Contrast, Exposure and Shadows. The interface is preferably displayed on a touch screen, with high sensitivity pad and low energy consumption.

### Dispenser Modules

This dispenser comprises:

Optional Bank note reader—Bank note reader accepts and stacks notes and typically has a cashbox for notes.

Optional Slip printer—preferably a ultra-compact direct thermal printer, with high performance printing.

Optional Card Slot Reader Module—The card reader module is preferably capable to read contact and contactless cards. Also, it preferably allows credit cards to be used, meaning that the same system can use 3 different types of cards.

These previous modules may be optionally grouped in a user interaction module.

Card Storage Module—The Card Storage Module is where the ID documents are stored before (and/or after) the delivery. It is composed by one, two, three or more groups of card containers, each one of the card containers containing a number of electronic documents. The axis is managed by the dispenser computer and may run in horizontal or vertical way. The dispenser sends to the axis controller the positions for picking up a specific document. The document is optionally read on the card slot, and the workflow for renewal or delivery of the card begins.

### Card Containers

The dispenser is equipped with document card containers. These card containers may also work with a mechanical lock. This means that preferably after the cards are inserted into the card containers, they can only be removed when inserted in the system, as the card containers will preferably only open when inserted inside the dispenser, optionally by means of an axis. Preferably, the card containers are circular, with the cards disposed around a central point for rotating around said axis, what is commonly known as a carrousel. Preferably, the axis will then unlock the card containers and it will be ready to start the card delivery.

### Card Containers Workflow

The card containers are usually first located at the ID Card. Production Facilities, empty. This is the typical life cycle of a card container:
1—The ID Cards are printed.
2—The ID Cards are inserted into the card container, in a location specified within the card container. Each group of card containers is prepared to be sent to a specific dispenser location. Each card container preferably has an ID, optionally stored on a card container chip, which contains optional information about the time, day; location, and dispenser ID number (for where the card container should be sent).
3—Optionally, the card container contains a card, called “zero” card, which contains the information of all the other cards (position and number). Once the card container is inserted on the dispenser, the dispenser will read the “zero” card, and will save on its memory the position of all the cards on that card container. Alternatively, the card container chip may store this information. Alternatively, this information may be obtained from a central server by the dispenser.
4—Once the card containers are empty, they can be collected from the dispenser, and sent again to the ID Card Production facilities, where it will receive new cards.
5—The system is optionally able to perform an intelligent card management. This means that if a card container is partially full, the system may take the remaining cards, remove them and insert them in another partially full card container, in order to obtain an empty card container. The empty card container is, after this process, ready to be replaced by another full card container. The system uses the database of the location of the cards, which is loaded in the moment the card containers are put into the dispenser, and at all moments, knows the positions of the empty slots of each card container and the position of the respective ID cards. With this information, the dispenser is able to re-organize the card containers. This allows a better performance of the dispenser. Also, documents that are more than a certain time stored in the dispenser, can be grouped in specific card containers, and taken out, reducing the time of “dead cards” inside the dispenser, while ensuring the cards are handled securely.

### Linear Loader Embodiment

An embodiment of the present invention comprises sequential, FIFO or LIFO, loading containers 71, 72, 73, 74 of ID cards 70, for loading into and out from the dispenser storage module 20. These loading containers are preferably constructed to only open when Coupled to the storage module 20, and otherwise securing the cards from and to the ID card production facility.

These containers are of a lighter and less expensive construction that the invention containers that should enable direct access to all card positions, whereas these can be FIFO—first-in-first-out or LIFO—last-in-first-out. The loading containers can be coupled to the dispenser when carrying cards from the production facility 71, emptied onto the dispenser 72, until empty 73. When empty, and optionally, the loading container can receive the left-over cards that are to be removed from the dispenser 74, and carry these back, e.g. to the production facility or for being destroyed.

On loading and/or unloading the dispenser is able to store and retrieve the ID cards at the appropriate positions at the ID card containers 30.

Preferably, the loading ID card containers 71, 72, 73, 74 do not need to be placed inside the dispenser, only requiring a secure coupling, so that one or more loading dispensers can be simultaneously attached to the outside of the dispenser. Preferably, the loading ID card containers are placed vertically at the top of the dispenser such that the cards weight can be used to facilitate loading. Also, a spring mechanism may be used to push out the ID cards.

### BRIEF DESCRIPTION OF DRAWINGS

The following figures provide preferred embodiments for illustrating the description and should not be seen as limiting the scope of invention.

FIG. 1: Schematic representation of a first dispenser embodiment where:

(10) represents a user interaction module,
(20) represents a card storage module,
(30) represents a card container,
(1) represents a confirmation slip printer,
(2) represents a touch screen,
(3) represents a bank note reader and respective opening, and
(4) represents a card reader and respective opening.

FIG. 2: Schematic representation of a second dispenser embodiment where:

(10) represents a user interaction module,
(20) represents a card storage module,
(40) represents a biometric module,
(1) represents a confirmation slip printer,
(2) represents a touch screen,
(3) represents a bank note reader and respective opening, and
(4) represents a card reader and respective opening.

FIG. 3: Schematic representation of an embodiment of a circular card container (31).

FIG. 4: Schematic representation of an embodiment of a circular card container where:

(32) represents the card container,
(50) represents an enclosure, and
(51) represents an electronic circuit.

FIG. 5: Schematic representation of top and side views of previous card container (32) embodiment.

FIG. 6: Schematic representation of an embodiment of a linear card container (33).

FIG. 7: Schematic representation of top and side views of previous card container (33) embodiment.

FIG. 8: Schematic representation of a third dispenser embodiment where:

(20) represents a card storage module, and
(33) represents a linear card container.

FIG. 9: Schematic representation of a detail (A) of the previous figure, where (33) represents a linear card container.

FIG. 10: Schematic representation of an embodiment of a circular card container (34).

FIG. 11: Schematic representation of a detail (B) of the previous figure where:

(34) represents the circular card container, and
(52) represents a connector between consecutive card containers.

FIG. 12: Schematic representation of an embodiment of a circular card container (35).

FIG. 13: Schematic representation of top and side views of previous card container (35) embodiment.

FIG. 14: Schematic representation of a fourth dispenser embodiment where:

(20) represents a card storage module,
(30) represents a card container,
(40) represents a biometric module,
(60) represents a card extractor,
(4) represents a card reader and respective opening.

FIG. 15: Schematic representation of another embodiment where:

(20) represents a card storage module,
(70) represents an ID card, and
(71, 72, 73, 74) represent loading ID card containers.

FIG. 16: Schematic representation of another embodiment where:

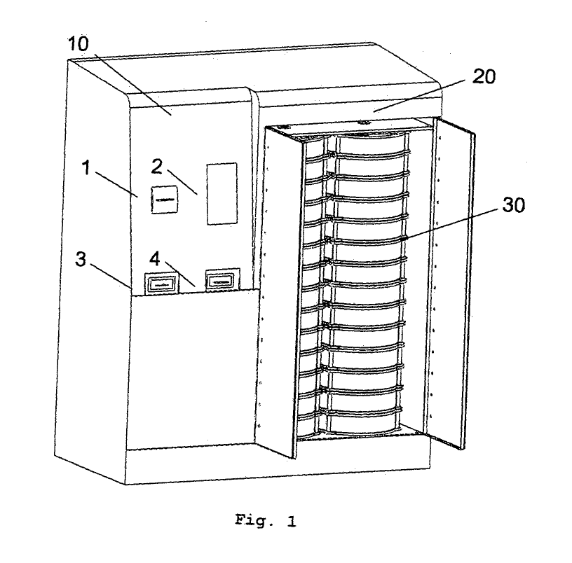

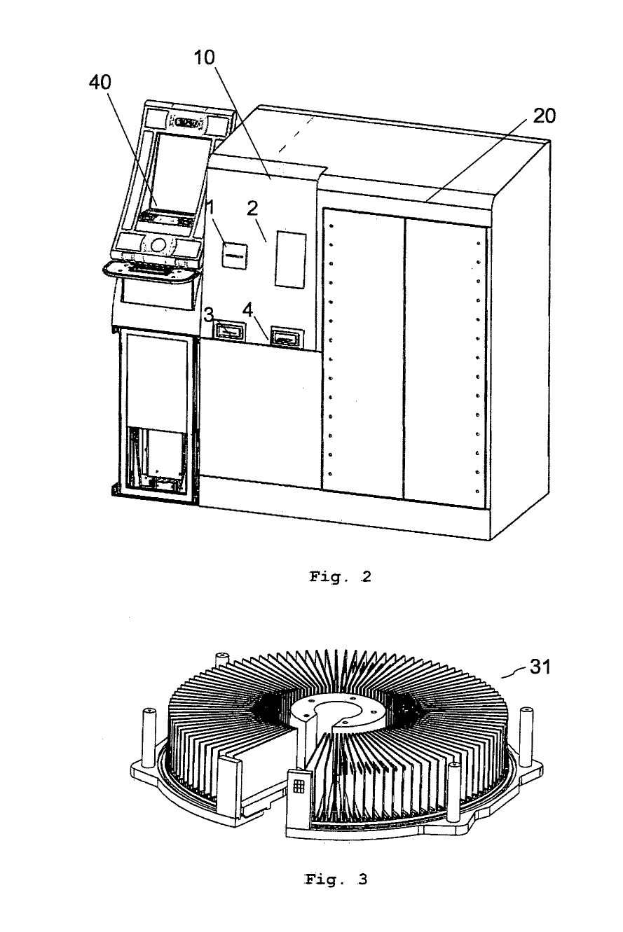

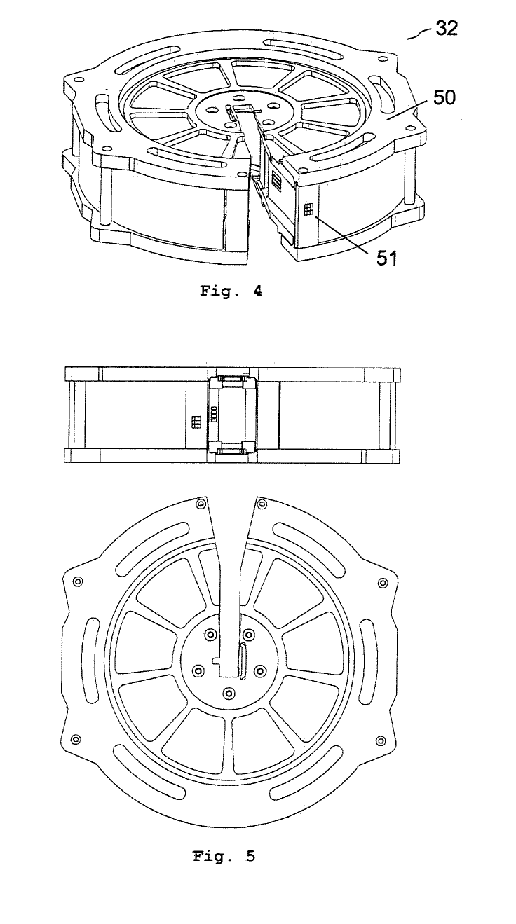

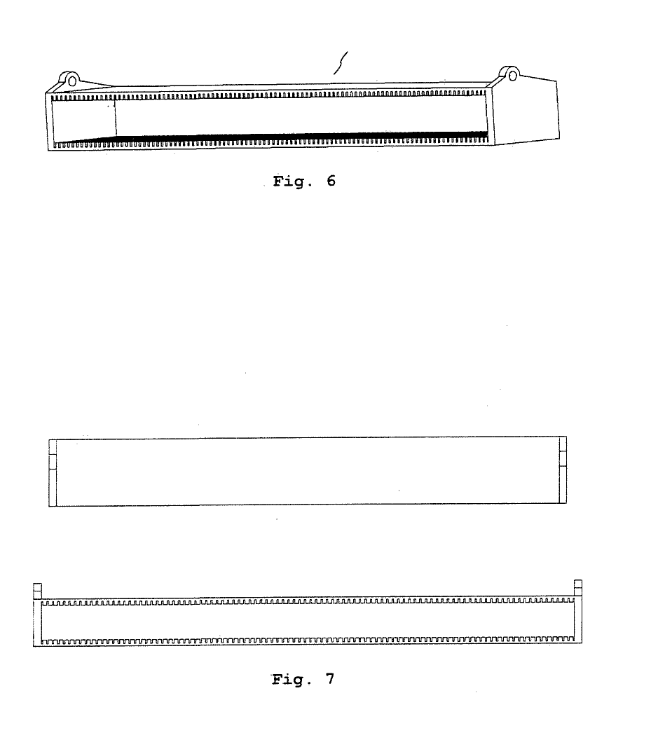

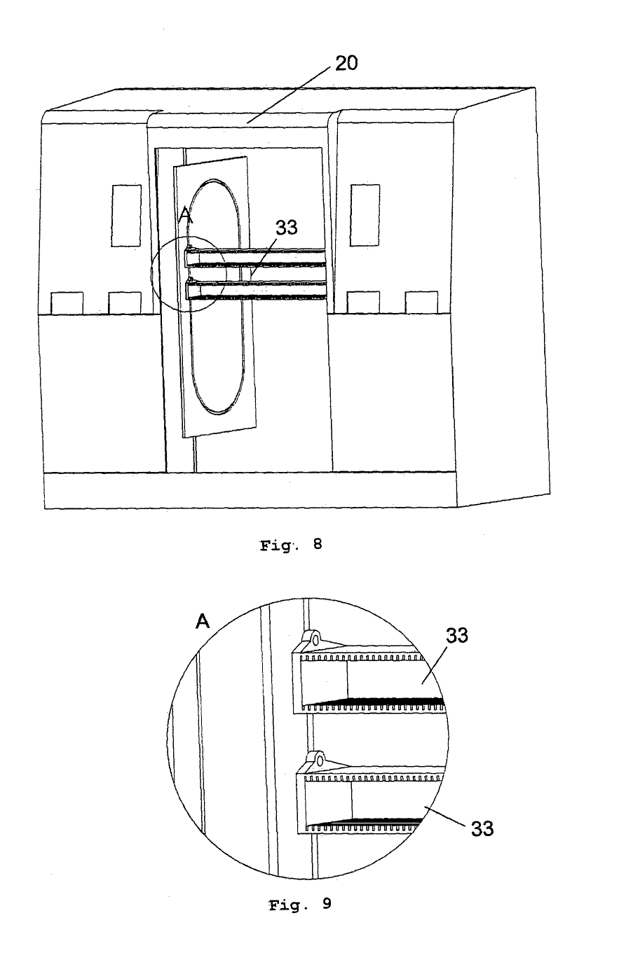

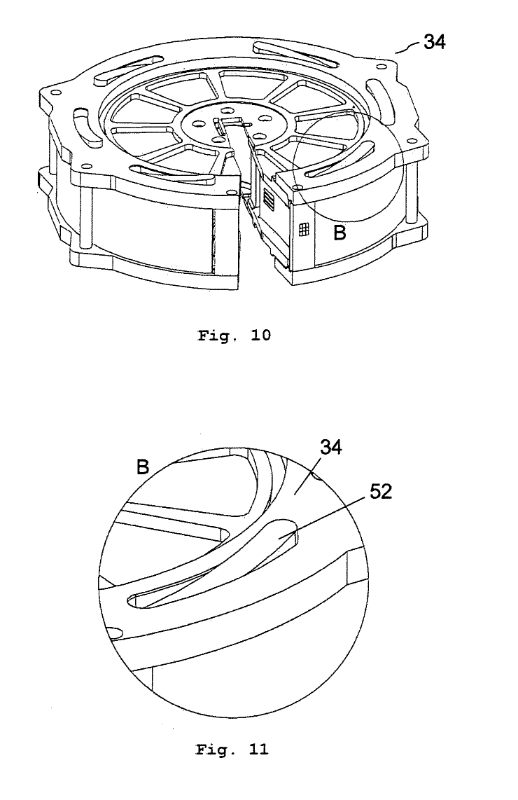

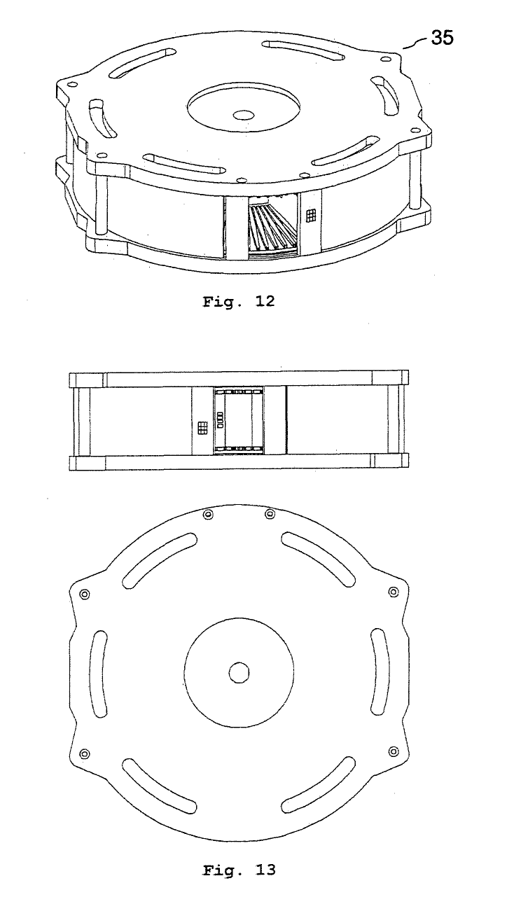

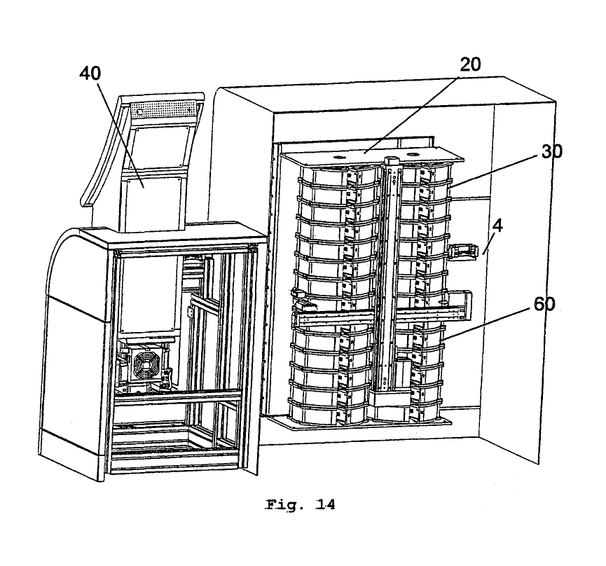

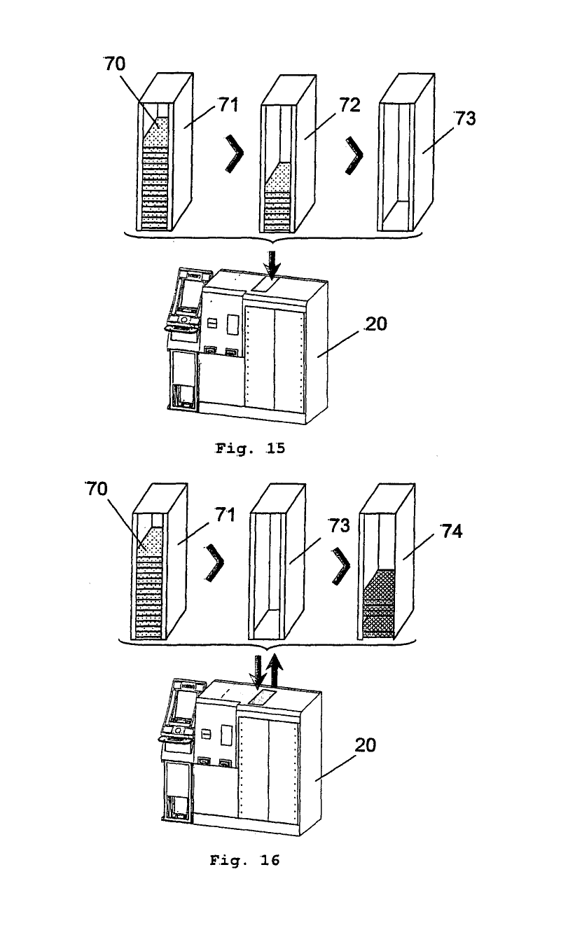

(20) represents a card storage module,
(70) represents an ID card, and
(71, 72, 73, 74) represent loading ID card containers.

The following claims set out particular embodiments of the invention.

1. An identification card (ID) dispenser comprising:
an ID card storage module for receiving and coupling with one or more ID card containers with a plurality of positions for receiving an ID card;
a ID card extractor for picking ID cards from the ID card containers;
wherein the ID card extractor has access to the individual ID card positions of the ID card containers.

2. The identification card (ID) dispenser according to claim 1 wherein the ID card containers are removable from the dispenser and thus suitable for uncoupling from the ID card storage module.

3. The identification card (ID) dispenser according to claim 1 wherein the ID card containers comprise an enclosure such that the ID cards are not accessible when its ID card container is uncoupled from the dispenser.

4. The identification card (ID) dispenser according to claim 1 wherein the ID card containers are circular and suitable for rotating around its centre.

5. The identification card (ID) dispenser according to claim 4 wherein the ID card containers comprise an ouverture for receiving a central axis.

6. The identification card (ID) dispenser according to claim 3 wherein the ID card containers enclosure is arranged to lock or unlock by a security lock, which releases through a logical command from the storage module, when all its access doors are closed.

7. The identification card (ID) dispenser according to claim 4 wherein the ID card containers are arranged to rotate horizontally in one or more vertical stacks, rotate through the same vertical axis.

8. The identification card (ID) dispenser according to claim 4 wherein the ID card containers comprises a connector between consecutive card containers so that the card containers can be rotated by a neighbour ID card container.

9. The identification card (ID) dispenser according to claim 1 wherein the ID card containers are linear.

10. The identification card (ID) dispenser according to claim 1 wherein each ID card container comprises an electronic circuit configured to one or more of the following:
identify said ID card container;
store an ID card inventory of the ID cards in said ID card container;
record, sound an alarm or send an alarm communication if an ID card is removed or the enclosure is open said ID card container.

11. The identification card (ID) dispenser according to claim 1, further comprising a user interaction module.

12. The identification card (ID) dispenser according to claim 1, further comprising a biometric module.

13. The identification card (ID) dispenser according to claim 1, further comprising a confirmation slip printer, a touch screen, a bank note reader and respective opening, and a card reader and respective opening and mechanical and logical interfaces to be connected to one or more storage modules, to one or more payment modules.

14. The identification card (ID) dispenser according to claim 1, comprising an ID card storage module for reading contact and contactless cards, for receiving and coupling with one or more ID card loading containers wherein:
the ID card extractor has access to the sequential ID card positions of the ID card loading containers and is able to unload, or load, or load and unload ID cards from said loading containers;
the ID card loading containers are removable from the dispenser and therefore suitable for uncoupling from the ID card storage module.

15. The identification card (ID) dispenser according to claim 14, wherein said sequential ID card position access of the ID card loading containers is first-in-first-out or last-in-first-out.

16. The identification card (ID) card container for the dispenser of claim 1 comprising a plurality of positions for receiving an ID card, wherein:
the ID card container is arranged to be inserted and couple with the ID card storage module of said dispenser;
the ID card container is arranged such that individual ID card positions are accessible the ID card extractor of said dispenser;
the ID card container is removable from the dispenser and suitable for uncoupling from said ID card storage module.

17. The identification card (ID) card container for the dispenser includes an operation method of the dispenser of claim 1 comprising the steps of:
receiving in a card storage module one or one or more ID card containers with a plurality of positions with ID cards;
coupling said ID card containers with the card storage module;
dispensing ID cards;
re-arranging ID cards in the ID card containers, such that if sufficient empty card positions are present, one or more containers can be emptied and, subsequently, uncoupled and extracted from the dispenser;
optionally, refill the card storage module with one or one or more ID card containers with ID cards.

18. The identification card (ID) card container for the dispenser includes an operation method of the dispenser according to claim 17, further comprising:
unlocking the enclosure of an ID card container when coupled with the card storage module;
locking the enclosure of an ID card container when uncoupled with the card storage module;
such that the ID cards are not accessible when its ID card container is uncoupled from the card storage module, and are accessible when in use by the dispenser.

19. The identification card (ID) card container for the dispenser includes an operation method of the dispenser of claim 12 with the biometric module, is characterized by comprising the following steps for delivery a ID card:
user inserts in the touch screen personally identifiable information;
user performs a biometric check, comparing the live biometric data captured, with the data stored on the ID card and/or the biometric data stored on the issuance authority database;
user make the payment if required for deliver the ID card;
the dispenser delivers the ID card to the user and sends a delivery information to the database of the issuance authority; and
dispenser prints a confirmation slip to the user if required for the user.

20. The identification card (ID) card container for the dispenser includes an operation method of the dispenser of claim 12 having the biometric module, is characterized by comprising the following steps for renewal and delivery of a ID card:
user inserts the old ID card;
dispenser verifies the conditions of the card for the renewal by communicating electronically with the ID card;
the dispenser performs a biometric check, matching the biometric data stored on the ID card, and/or the biometric data stored on the issuance authority database, with the live biometrics captured and blocking the card data;
the verification of information is made between the dispenser and the central server database of the issuance authority if required;
after the biometric check is confirmed, new biometrics data is enrolled by the dispenser, to keep them up to date in the new card and/or central database;
user makes the payment if required for delivery of the ID card;
dispenser prints a confirmation slip to the user if required by the user;
dispenser delivers the ID card to the user;
old ID card is stored on a card container; and
the information of the renewal and the delivery is sent to the database of the issuance authority;

21. The identification card (ID) card container for the dispenser wherein the operation method of the dispenser identified of claim 19, is characterized by comprising a closed-circuit television camera installed on and inside the dispenser.

22. The identification card dispenser with the biometric module according claim 12, characterized for comprising a fixed or height adjustable user interaction module with biometric capture devices, namely:
fingerprint readers for capture and matching performance;
camera for face enrolment and matching;
camera for live video recording;
pad for signature capture;
height measuring; and
Camera for iris capture.

23. A system of intelligent card management, characterized by obtaining an empty card container and a full card container from two partial full containers.

24. The system of intelligent card management according to claim 23, characterized for comprising the following steps:
cards are loaded when are put into the card container;
a database of the localization of the cards into the card container is populated;
the card containers within the cards are put into the dispenser;
the dispenser is connected to a central system which manage the cards and the cards containers;
the empty slots of each card container, the position of the empty slots of each card container and the position of the respective card are localized any time by the system through the database;
with the information obtained through the last step the dispenser reorganize the card containers to obtain an empty card container and a full card container;
the empty card container is replaced by another full card container.
